(19) United States
(12) Patent Application Publication
(10) Pub. No.: US 2006/0245515 A1
(43) Pub. Date: Nov. 2, 2006

(54) Data reception apparatus and synchronizing signal detection method and program

(75) Inventor: Nobuyuki Tachi, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/412,173

(22) Filed: Apr. 27, 2006

(30) Foreign Application Priority Data
Apr. 28, 2005 (JP) 2005-131592

(51) Int. Cl. H04L 25/49

(52) U.S. Cl. 375/293

(57) ABSTRACT

To detect the Synch Field accurately and find the beginning of a frame in order to calculate the baud rate. A slave device is connected to a bus and receives a binary level signal on the bus transmitted from a master device. The slave device detects the signal level of the binary level signal and calculates the time of a first period and a second period when the binary level signal is at a low level, which respectively exist before and after the binary level signal is at a high level. When the ratio of the first period to the second period is not less than 11, the binary level signal that the device continues to receive after the second period is identified as the Synch Field. From the reciprocal number of the second period, the baud rate for the slave device to receive the binary level signal is calculated.

### FIELD OF THE INVENTION

The present invention relates to a data reception apparatus and synchronizing signal detection method and program, and particularly to a data reception apparatus that receives a binary level signal on a bus, and a method and a program for detecting a synchronizing signal in the binary level signal.

### BACKGROUND OF THE INVENTION

In recent years, the demand for automotive LAN has increased and the most suitable network for each application has been utilized. LIN (Local Interconnect Network) is a communication protocol for automotive LAN. It is a serial communication protocol based on a master-slave structure and is mainly used in simple systems such as a body system. In the LIN communication protocol, there are a Synch Break Field that indicates the beginning of a frame and a field of a synchronizing signal called Synch Field that follows the Synch Break Field, and by transmitting the Synch Field from the master to the slave, the slave receives data based on the baud rate in the Synch Field (refer to Patent Document 1).

Meanwhile, a communication method between user terminal equipment and data circuit terminating equipment using asynchronous transmission serial data is known. In this communication method, particular codes called AT command (41h and 61h in hexadecimal notation) are transmitted first. Because the least significant bit (LSB) of each of both is 1, a space (start bit) of one bit certainly appears at the beginning of the communication when each of both is converted into the LSB-first bit series of a serial interface. The communication rate is obtained by measuring the time of this space (for instance refer to Patent Document 2).

[Patent Document 1]

Japanese Patent Kokai Publication No. JP-P2004-228945A

[Patent Document 2]

Japanese Patent Kokai Publication No. JP-P2000-209302A

The entire disclosure of the Patent Documents 1 and 2 is herein incorporated by reference thereto.

### SUMMARY OF THE DISCLOSURE

According to the specification of the LIN protocol, the Synch Break Field is a pulse that continues at a low level of 11 bits or more, followed by a high level, and further followed by the Synch Field of 01010101 (0 and 1 indicate low level and high level respectively). Meanwhile, when a slave on that the baud rate is to be measured starts up, the first signal that it receives is not always the Synch Break Field because the master that transmits the signal to the slave does not guarantee that it operates in sync with the slave when the slave starts up. Therefore, even when the slave simply passes the first pulse up, pays attention to the second pulse, and measures the pulse width to obtain the baud rate using a technology such as the one disclosed in Patent Document 2, it is not guaranteed that the second pulse is the start bit of the Synch Field. In other words, the slave cannot receive accurate data by obtaining the baud rate from the second pulse and receiving data thereafter. Thus there is much to be desired in the art.

According to an aspect of the present invention there is provided a data reception apparatus that is connected to a bus and receives a binary level signal on the bus. This reception apparatus comprises a signal detection unit that detects the signal level of the binary level signal; a period calculation unit that calculates first and second periods when the binary level signal is at a second level, which are respectively detected before and after periods when the binary level signal is at a first level; a comparison unit that calculates the ratio of the first period to the second period; and a synchronization detection unit that identifies a binary level signal that follows the second period as a synchronizing signal when the ratio calculated by the comparison unit is not less than a predetermined value.

Also there is provided a synchronizing signal detection method according to another aspect of the present invention, wherein a data reception apparatus that is connected to a bus and that receives a binary level signal on the bus detects a synchronizing signal of the binary level signal. In this method, first and second periods when the binary signal is at a second level, which are respectively detected before and after periods when the signal is at a first level, are calculated; and the binary level signal received after the second period is identified as a synchronizing signal when the ratio of the first period to the second period is not less than a predetermined value.

According to a further aspect of the present invention there is provided a program that has a computer constituting a data reception apparatus that is connected to a bus and that receives a binary level signal on the bus execute the following processing steps:

a time processing in which a time interval between a first point when the signal level of the binary level signal changes from a first level to a second level and a second point when it changes from the second level to the first level is measured;

a processing in which a time interval that has been already stored in a memory unit is outputted for comparison at the second point and the time interval measured in the time processing is stored in the memory unit;

a comparison processing in which a ratio of a time interval that has been already stored in the memory unit to a time interval measured in the time processing is calculated; and

a detection processing in which the binary level signal being received thereafter is detected as a synchronizing signal when the ratio calculated in the comparison processing is not less than a predetermined value.

The meritorious effects of the present invention are summarized as follows.

According to the present invention, the beginning of a frame is found by calculating the ratio between a first pulse width and a second pulse width, therefore a synchronizing signal can be accurately detected and the baud rate can be obtained.

### BRIEF DESCRIPTION OF THE DRAWINGS

FIG. 1 is a block diagram illustrating the structure of a data reception apparatus relating to an embodiment of the present invention.

FIGS. 2A, 2B and 2C show flowcharts illustrating the operation of the data reception apparatus relating to the first embodiment of the present invention.

FIGS. 3A, 3B and 3C show flowcharts illustrating the operation of a data reception apparatus relating to a second embodiment of the present invention.

### PREFERRED EMBODIMENTS OF THE INVENTION

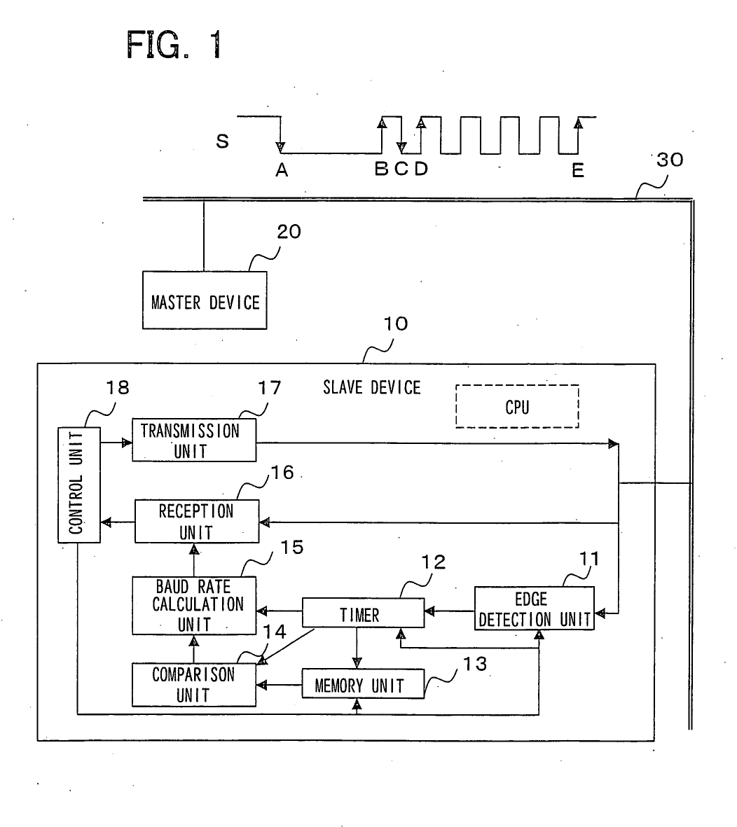

A data reception apparatus relating to a first embodiment of the present invention is connected to a bus (30 in FIG. 1) and receives a binary level signal (S in FIG. 1) on the bus. This device detects the signal level of the binary level signal and calculates the time of a first period (between A and B in FIG. 1) and a second period (between C and D in FIG. 1) when the binary level signal is at a low level, which respectively exist before and after periods when the binary level signal is at a high level. When the ratio of the second period to the first period is not less than a predetermined value (for instance 11), the binary level signal that the device continues to receive after the second period is identified as a Synch Field. And from the reciprocal number of the second period, the baud rate for the data reception apparatus to receive the binary level signal is calculated. Further, a data field that follows the Synch Field is received based on the calculated baud rate. Hereinafter, embodiments of the present invention will be described in detail with reference to the drawings.

### Embodiment 1

FIG. 1 is a block diagram illustrating the structure of a communication system relating to a first embodiment of the present invention. In FIG. 1, the communication system is structured so that a slave device 10 and a master device 20 are connected to a bus 30. First, the master device 20 transmits a binary level signal S on the bus 30. The slave device 10 receives the binary level signal S, and then a predetermined binary level signal is transmitted/received between the slave device 10 and the master device 20 as necessary.

The slave device 10 comprises an edge detection unit 11, a timer 12, a memory unit 13, a comparison unit 14, a baud rate calculation unit 15, a reception unit 16, a transmission unit 17, and a control unit 18. Further, a CPU and a program may be implemented in the slave device 10, and each of the above or some of the above may be operated by having the CPU execute the program.

The edge detection unit 11 receives the binary level signal S that the master 20 transmits and that exists on the bus 30, and detects rising edges (for instance B, D, and E) and falling edges (for instance A and C) of the binary level signal S. The timer 12 starts when there is a falling edge and stops when there is a rising edge. The memory unit 13 stores the value of the timer when the timer 12 stops. The comparison unit 14 calculates the ratio of the value of the timer 12 against the value that the memory unit 13 has stored when the timer 12 stops. The baud rate calculation unit 15 calculates the baud rate of the binary level signal transmitted by the master device 20 from the reciprocal number of the value of the timer 12 when the ratio outputted by the comparison unit 14 is not less than a predetermined value, for instance 11. Note that the number 11 is simply derived from the specification of the LIN protocol, and the predetermined value is not limited to this. The reception unit 16 receives the binary level signal S on the bus 30 according to the baud rate calculated. The transmission unit 17 transmits data such as a response to the data that the reception unit 16 has received on the bus 30 according to the calculated baud rate as necessary. The control unit 18 controls the edge detection unit 11, the timer 12, the memory unit 13, the reception unit 16, and the transmission unit 17.

Meanwhile, the master device 20 receives the data transmitted by the transmission unit 17. Note that the slave device 10 and the master device 20 comprise various circuits that make these devices function other than the ones described above, however, they will not be described and are omitted from the drawing since they are not related to the present invention.

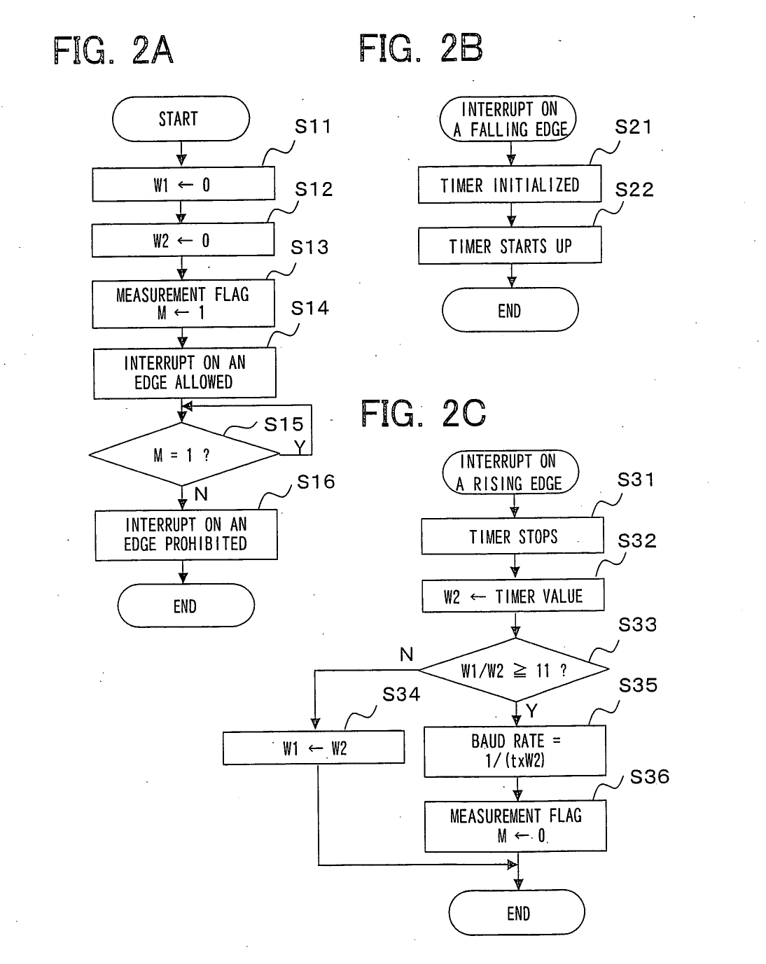

Next, how the slave device receives the binary level signal S will be described. FIGS. 2A-2C show flowcharts illustrating the operation of the slave device relating to the first embodiment of the present invention. FIG. 2A shows the flowchart of a main processing, FIG. 2B shows the flowchart of an interrupt processing on a falling edge of the binary level signal S, and FIG. 2C shows the flowchart of an interrupt processing on a rising edge of the binary level signal S.

First, the main processing in FIG. 2A will be described. When a synchronizing signal detection process starts in the main processing, as an initialization process, a variable W1 that stores the pulse width is set to 0 (a step S11), a variable W2 that stores the pulse width is set to 0 (a step S12), and a measurement flag M indicating it is in the process of measuring is set to 1 so that it is in a state of measuring (a step S13). Then, an interrupt on an edge of the binary level signal S is allowed (a step S14).

In step S15, the device waits for the completion of the measurement when the measurement flag M is 0 indicating the measurement is completed in a step S36 discussed later. In other words, it checks whether or not the measurement flag M is 1, and when the measurement flag M is 1, the step S15 is repeated. When the measurement flag M is not 1 (when it is 0), it proceeds to step S16 since the measurement has been completed.

In the step S16, any interrupt on an edge is prohibited and a sequence of the processing comes to an end.

In the step S15 of the main processing, an interrupt occurs when the edge detection unit 11 detects a falling edge of the binary level signal S, and the interrupt processing on a falling edge shown in FIG. 2B is executed. In the interrupt processing on a falling edge, the timer 12 is initialized (a step S21), the timer 12 starts up (a step S22), the interrupt processing is ended, and a return to the step S15 is made.

Next, the interrupt processing on a rising edge shown in FIG. 2C will be described. In the step S15, an interrupt occurs when the edge detection unit 11 detects a rising edge of the binary level signal S, and the interrupt processing on a rising edge shown in FIG. 2C is executed. In the interrupt processing on a rising edge, the timer 12 is stopped (step S31), the value of the timer 12 is set to the variable W2 (step S32).

In step S33, W1/W2 (the ratio between W1 and W2) is investigated. When W1/W2 is 11 or more, the processing proceeds to a step S35 since the beginning of a frame is detected, and when W1/W2 is less than 11, it proceeds to step S34 since the beginning of a frame is not detected. Note that, when going through the step S33 at the start of the processing, it proceeds to the step S34 since W1 is 0.

In the step S34, the variable W2 is substituted for W1, the interrupt processing comes to an end, and the processing returns to the step S15 in order to wait for next pulse width measuring.

In the step S35, since the variable W2 is the count value of the timer corresponding to the 1 bit width, the baud rate is calculated as follows: 1/(t×W2). Here, t is the resolution of the timer 12. For instance, if the resolution t is 1 μs and the value of the variable W2 is 104, the baud rate will be calculated as follows: 1/(0.000001×104)=9615 bps.

In the step S36, the measurement flag M is set to 0 since the baud rate has been measured, the interrupt processing is ended, and a return to the step S15 is made.

As described above, the slave device 10 operates and calculates the ratio between the first pulse width (W1) and the second pulse width (W2). When the ratio is 11 or more, it determines that the first pulse is the Synch Break Field and the binary level signal that follows the second pulse is the Synch Field. And from the value of the variable W2, the baud rate for receiving data thereafter can be calculated.

### Embodiment 2

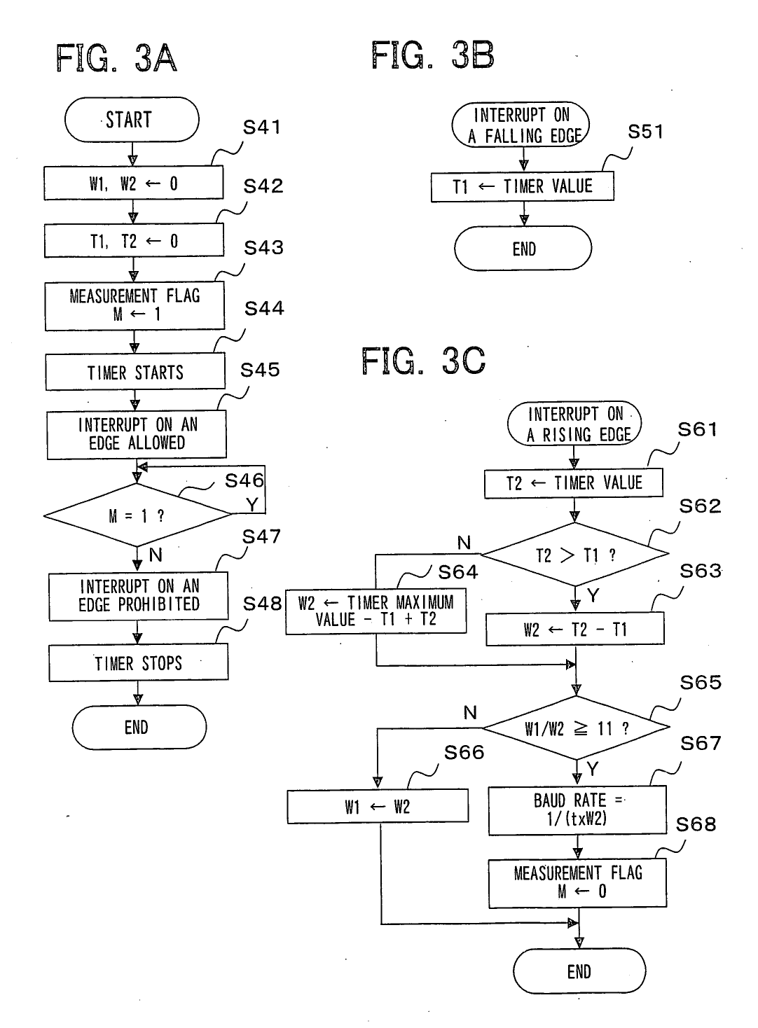

FIGS. 3A, 3B and 3C show flowcharts illustrating the operation of a slave device relating to the second embodiment of the present invention. FIG. 3A show the flowchart of a main processing, FIG. 3B shows the flowchart of an interrupt processing on a falling edge of the binary level signal S, and FIG. 3C shows the flowchart of an interrupt processing on a rising edge of the binary level signal S. In the first embodiment, the timer starts up at a falling interrupt and stops at a rising interrupt, however, in the second embodiment, the timer continues to operate, counts the lapse of time and derives the pulse width.

First, the main processing in FIG. 3A will be described. When a synchronizing signal detection process starts in the main processing, as an initialization process, variables W1 and W2 that store the pulse width are set to 0 (a step S41), variables T1 and T2 that store the timer value are set to 0 (a step S42), and the measurement flag M indicating it is in the process of measuring is set to 1 (a step S43). Then, the timer starts up (a step S44) and an interrupt on an edge of the binary level signal S is allowed (a step S45).

In step S46, the device waits for the completion of the measurement at which the measurement flag M becomes 0 when the measurement is completed in step S68 discussed later. In other words, it checks whether or not the measurement flag M is 1, and when the measurement flag M is 1, the step S46 is repeated. When the measurement flag M is not 1 (when it is 0), it proceeds to step S47 since the measurement has been completed.

In step S47, any interrupt on an edge is prohibited. Further, the timer is stopped (step S48) and a sequence of the processing comes to an end. Note that the timer may be kept operating, and in this case, the steps S44 and S48 may be omitted.

In the step S46 of the main processing, an interrupt occurs when the edge detection unit 11 detects a falling edge of the binary level signal S, and the interrupt processing on a falling edge shown in FIG. 3B is executed. In the interrupt processing on a falling edge, the value of the timer is stored in the variable T1 (step S51), the interrupt processing is ended, and a return to the step S46 is made.

Next, the interrupt processing on a rising edge shown in FIG. 3C will be described. In the step S46, an interrupt occurs when the edge detection unit 11 detects a rising edge of the binary level signal S, and the interrupt processing on a rising edge shown in FIG. 3C is executed. In the interrupt processing on a rising edge, the value of the timer is set to the variable T2 (step S61).

In step S62, the relationship between T2 and T1 is investigated. The processing proceeds to step S63 when T2 is bigger than T1, and it proceeds to step S64 when T2 is smaller or equal to T1.

In the step S63, the difference between T2 and T1 (T2−T1) is substituted for the variable W2 and the processing proceeds to step S65.

In the step S64, since the timer is determined to have overflowed, the measurement value between the minimum value of the timer i.e., 0 and T2 is added to the measurement value between T1 and the maximum value of the timer (the maximum value of the timer−T1+T2) and the result is substituted for the variable W2. Then the processing proceeds to step S65.

In the steps S65 through S68, the same processings are performed, therefore the explanation on these steps are eliminated.

As described above, the slave device 10 operates and is able to calculate the baud rate for receiving data as in the first embodiment.

It should be noted that other objects, features and aspects of the present invention will become apparent in the entire disclosure and that modifications from the disclosed embodiments may be done without departing the scope of the present invention claimed as appended herewith.

Also it should be noted that any combination of the disclosed and/or claimed elements, matters and/or items may fall under the modifications aforementioned.

What is claimed is:

1. A data reception apparatus that is connected to a bus and that receives a binary level signal on the bus comprising:
a signal detection unit that detects the signal level of said binary level signal;
a period calculation unit that calculates first and second periods when said binary level signal is at a second level, which are respectively detected before and after periods when said binary level signal is at a first level;
a comparison unit that calculates a ratio of said first period to said second period; and
a synchronization detection unit that identifies a binary level signal that follows the second period as a synchronizing signal when the ratio calculated by said comparison unit is not less than a predetermined value.

2. The data reception apparatus as defined in claim 1 wherein said period calculation unit comprises a timer that measures a time interval between a first point when the signal level of said binary level signal changes from said first level to said second level and a second point when it changes from said second level to said first level, and a memory unit that outputs a time interval that has been already stored as said first period at said second point and that stores the time interval measured by said timer as said second period.

3. The data reception apparatus as defined in claim 1 further comprising a baud rate calculation unit that calculates a baud rate for receiving said binary level signal based on said synchronizing signal.

4. The data reception apparatus as defined in claim 3 wherein said baud rate calculation unit calculates said baud rate from the reciprocal number of said second period when the ratio calculated by said comparison unit is not less than said predetermined value.

5. A synchronizing signal detection method wherein a data reception apparatus that is connected to a bus and that receives a binary level signal on the bus detects a synchronizing signal of the binary level signal, the method comprises:
calculating first and second periods when said binary signal is at a second level, which are respectively detected before and after periods when said binary signal is at a first level, and
identifying said binary level signal received after said second period as a synchronizing signal when the ratio of said first period to said second period is not less than a predetermined value.

6. The synchronizing signal detection method as defined in claim 5 wherein a baud rate for receiving said binary level signal is calculated based on said synchronizing signal.

7. The synchronizing signal detection method as defined in claim 6 wherein the reciprocal number of said second period is calculated as said baud rate.

8. A program having a computer constituting a data reception apparatus that is connected to a bus and that receives a binary level signal on the bus execute the following processing steps:
a time processing in which a time interval between a first point when the signal level of said binary level signal changes from a first level to a second level and a second point when it changes from said second level to said first level is measured;
a processing in which a time interval that has been already stored in a memory unit is outputted for comparison at said second point and the time interval measured in said time processing is stored in said memory unit;
a comparison processing in which a ratio of a time interval that has been already stored in said memory unit to a time interval measured in said time processing is calculated; and
a detection processing in which said binary level signal being received thereafter is detected as a synchronizing signal when the ratio calculated in said comparison processing is not less than a predetermined value.

9. The program as defined in claim 8 having the computer further execute a baud rate calculation processing in which a baud rate for receiving said binary level signal is calculated based on said synchronizing signal.

10. The program as defined in claim 9 wherein said baud rate is calculated from a reciprocal number of the value of the time interval measured in said time processing when the ratio calculated in said comparison processing is not less than said predetermined value in said baud rate calculation processing.
